(19) United States
(12) Patent Application Publication
(10) Pub. No.: US 2025/0310082 A1
(43) Pub. Date: Oct. 2, 2025

(54) SEMICONDUCTOR DEVICE, PROCESSING METHOD, AND STORAGE MEDIUM

(71) Applicant: Sharp Semiconductor Innovation Corporation, Tenri City (JP)

(72) Inventor: Hiroaki ENDO, Tenri City (JP)

(21) Appl. No.: 19/058,334

(22) Filed: Feb. 20, 2025

(30) Foreign Application Priority Data
Apr. 1, 2024 (JP) 2024-058895

(51) Int. Cl. H04L 9/06

(52) U.S. Cl. CPC H04L 9/0631

(57) ABSTRACT

In order to further improve tamper resistance to a side-channel attack while suppressing an increase in operation time in a semiconductor device, a semiconductor device includes: a dividing section configured to divide data into two or more pieces of divisional data; a block encryption executing section configured to apply, to only one or some of the two or more pieces of divisional data, a specific process included in a block encryption algorithm; and a data retaining section configured to retain, in respective blocks, the two or more pieces of divisional data to only one or some of which the specific process has been applied, so that pieces of side-channel information radiated differ from each other between at least some of the blocks.

This Nonprovisional application claims priority under 35 U.S.C. § 119 on Patent Application No. 2024-058895 filed in Japan on Apr. 1, 2024, the entire contents of which are hereby incorporated by reference.

### TECHNICAL FIELD

The present invention relates to a semiconductor device, a processing method, a control program, and a storage medium.

### BACKGROUND ART

There is an increasing threat of a side-channel attack, in which a secret key (common key) information used in, for example, the Advanced Encryption Standard (AES) is obtained by analyzing side-channel information such as information on a change in power that occurs when data is stored on a register of a computer. Specific known examples of a method of the side-channel attack include: a power analysis attack in which secret information is inferred by analyzing a change in power consumption; and an electromagnetic analysis attack in which secret information is inferred by analyzing a change in an electromagnetic field that is radiated from a target device. Examples of a countermeasure against such a side-channel attack include masking in which a correlation between an intermediate value in encryption and the side-channel information is lowered by changing values of data in process to other values with use of, for example, random numbers. Patent Literature 1 discloses an encryption processing device capable of concurrently processing random numbers and regular data and concealing power consumption in processing the regular data by power consumption of the random numbers. Patent Literature 2 discloses an encryption device that is safe from a side-channel attack without increasing a circuit scale.

### CITATION LIST

### Patent Literature

### [Patent Literature 1]

Japanese Patent Application Publication Tokukai No. 2014-115579

### [Patent Literature 2]

Japanese Patent Application Publication Tokukai No. 2011-175039

### SUMMARY OF INVENTION

### Technical Problem

However, in conventional techniques as described above, in a case where masking is applied to AES, preprocessing is required. This causes a problem of increasing an operation time. Further, in the invention disclosed in Patent Literature 1, for example, in a case where one encryption key is used to encrypt plaintexts, there occurs a problem in that it is possible to extract only the regular data by analyzing an average value of a power consumption waveform and removing random number components. Furthermore, in the invention disclosed in Patent Literature 2, although an increase in operation time is relatively suppressed, there is room for improvement of tamper resistance.

An aspect of the present invention is attained in view of the above problems, and an object of an aspect of the present invention is to further improve tamper resistance to a side-channel attack while suppressing an increase in operation time in a semiconductor device.

### Solution to Problem

In order to solve the above problem, a semiconductor device in accordance with an aspect of the present invention includes: a dividing section configured to divide data into two or more pieces of divisional data; a block encryption executing section configured to apply, to only one or some of the two or more pieces of divisional data, a specific process included in a block encryption algorithm; and a data retaining section configured to retain, in respective blocks, the two or more pieces of divisional data to only one or some of which the specific process has been applied, so that pieces of side-channel information radiated differ from each other between at least some of the blocks.

In order to solve the above problem, a processing method in accordance with an aspect of the present invention is a data processing method which is carried out by a device, the method including: a dividing step of dividing data into two or more pieces of divisional data; a block encryption executing step of applying, to only one or some of the two or more pieces of divisional data, a specific process included in a block encryption algorithm; and a data retaining step of retaining, in respective blocks, the two or more pieces of divisional data to only one or some of which the specific process has been applied, so that pieces of side-channel information radiated differ from each other between at least some of the blocks.

### Advantageous Effects of Invention

An aspect of the present invention is capable of further improving tamper resistance to a side-channel attack while suppressing an increase in operation time in a semiconductor device.

### BRIEF DESCRIPTION OF DRAWINGS

FIG. 1 is an example of a block diagram illustrating a functional configuration of a computer which includes a semiconductor device.

FIG. 2 is an example of a flowchart illustrating a flow of a process by the semiconductor device.

FIG. 3 illustrates an example of a data diagram illustrating processing of data on a register.

FIG. 4 is a table showing an example of a relation between a clock and an intermediate value(s) d and a table showing an example of a relation between a Humming distance and a first clock and a second clock following the first clock.

FIG. 5 is an example of a flowchart illustrating a flow of a process by a semiconductor device.

FIG. 6 is a table showing an example of a correspondence relation between each 8 bits of input data, each 2 bits of a random number, and divisional data to which the each 8 bits of the input data are assigned.

FIG. 7 is a table showing an example of a correspondence relation between a 32-bit random number to which a ShiftRows process is applied, divisional data corresponding to each 2 bits of the random number, and first divisional data.

FIG. 8 shows an example of a data diagram illustrating processing of data on a register.

### DESCRIPTION OF EMBODIMENTS

### Embodiment 1

The following description will discuss an embodiment of the present invention in detail.

### 1. Configuration of Semiconductor Device

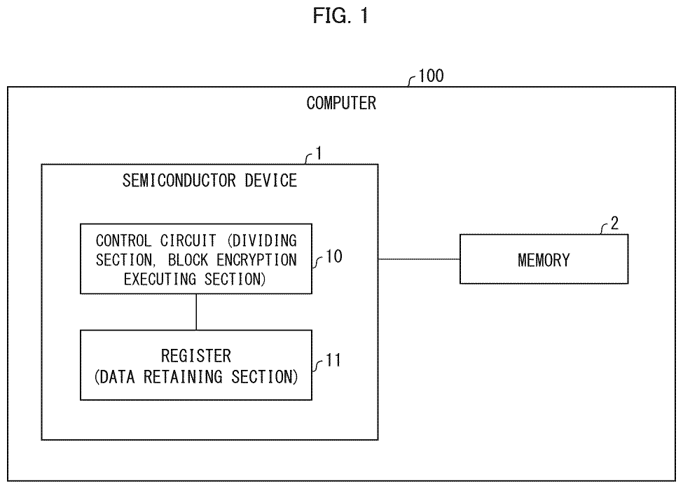

FIG. 1 is an example of a block diagram illustrating a functional configuration of a computer 100 which includes a semiconductor device 1 in accordance with the present disclosure. The computer 100 includes the semiconductor device 1, a memory 2 in which data is temporality or non-temporarily stored.

The semiconductor device 1 is realized by, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The semiconductor device 1 includes a control circuit 10 and a register 11.

The control circuit 10 performs various operations in sync with a clock signal, and also functions as a dividing section 10 that implements a dividing means, and a block encryption executing section 10 that implements a block encryption execution means. Alternatively, the control circuit 10 may include the dividing section 10 and the block encryption executing section 10. Further, the control circuit 10 may operate according to a program that is obtained from a memory 2 each time.

The dividing section 10 divides data to be processed into two or more pieces of divisional data. For example, the dividing section 10 divides 128-bit data into two pieces of 64-bit divisional data.

The block encryption executing section 10 applies a block encryption algorithm to data to be processed. For example, the block encryption executing section 10 applies, to only one or some of the two or more pieces of divisional data, a specific process included in the block encryption algorithm. An AddRoundKey process in the present embodiment is an example of the specific process included in the block encryption algorithm.

In the present disclosure, the Advanced Encryption Standard (AES) is discussed as an example of the block encryption algorithm, but the block encryption algorithm is not limited to the AES but any of other block encryption algorithms may be used.

In an AES process performed by the block encryption executing section 10, a SubBytes process, a ShiftRows process, a MixColumns process, and an AddRoundKey are repeatedly performed. The SubBytes process is a process for converting each byte of data to a predetermined value. The value of one byte prior to conversion corresponds, on a one-to-one basis, to the value of one byte after the conversion. The ShiftRows process is a process for putting the value of each byte in a plurality of columns to make an array, and shifting each row in a column direction by the number of columns that is different for each row. The MixColumns process is a process for converting values by multiplying, with a constant matrix from the left, an array having the value of each byte. The AddRoundKey process is a process for performing, every round, that is, every time the AddRoundKey process is performed, an exclusive disjunction (XOR) operation of a bit string of a round key corresponding to round number and a bit string of data.

The block encryption executing section 10 is capable of performing, in a batch, a plurality of processes such as the SubBytes process included in the AES process, for example, by a matrix operation.

Many of existing semiconductor devices perform, in an AES process, the AddRoundKey process once first, and then, repeat the SubBytes process, the ShiftRows process, the MixColumns process and the AddRoundKey process a plurality of times. Subsequently, the SubBytes process, the ShiftRows process and the AddRoundKey process are each performed once. The prescribed number of times is the number of time corresponding to a length of a round key that is used for the AddRoundKey process, and the number obtained by adding, to the prescribed number of times, one time that corresponds to the first AddRoundKey process is called round number. For example, in a case where the length of the round key is 128 bits, the prescribed number of times is 9 and the round number is 10.

The register 11 is a storage element in which various information is temporarily stored. The register 11 also functions as a data retaining section 11 for implementing a data retaining means. Alternatively, the register 11 may include a data retaining section 11.

The data retaining section 11 retains, in respective blocks, pieces of divisional data that are obtained by applying, to only some of the pieces of divisional data, a specific process such as the AddRoundKey process included in the block encryption algorithm. As viewed from another aspect, the blocks each mean a storage region of the register 11 which is obtained by dividing, as a matter of convenience, the register 11 for each divisional data to be retained.

### 2. Process by Semiconductor Device

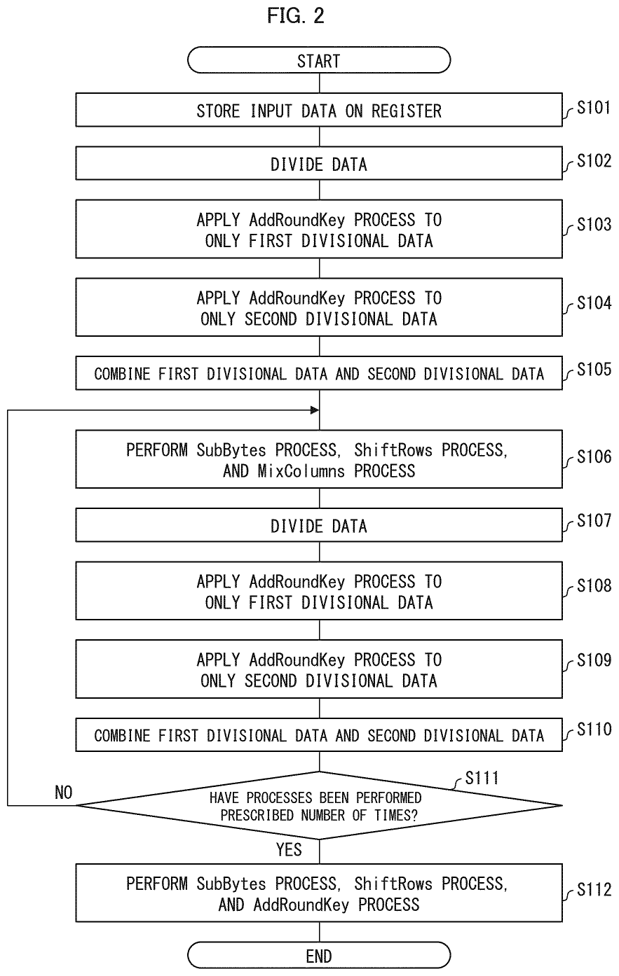

Next, the following will discuss a flow of a process to be performed by the semiconductor device 1. The present embodiment will discuss a case in which the control circuit 10 divides data into two pieces of divisional data. FIG. 2 is an example of a flowchart illustrating a flow of the process by the semiconductor device 1 in accordance with the present embodiment.

In step S101 (S101), the control circuit 10 obtains input data that is to be subject to the AES process, and stores the input data on the register 11. The following will discuss, as an example, a case where the input data is a 128-bit value “A0A1A2A3A4A5A6A7A8A9AAABACADAEAF”.

In S102, the control circuit (dividing section) 10 divides the data on the register 11 into two pieces of divisional data, that is, first divisional data and second divisional data. It is assumed that the first divisional data is stored on a first block of the register 11 and the second divisional data is stored on a second block of the register 11. For example, the control circuit 10 divides a 128-bit value “A0A1A2A3A4A5A6A7A8A9AAABACADAEAF” into 64-bit first divisional data “A0A1A2A3A4A5A6A7” and 64-bit second divisional data “A8A9AAABACADAEAF”. Note that as described above, since the AddRoundKey process is an XOR operation between bit strings, a division position of the data is not limited. Accordingly, it is not essential to divide the data at a multiple-of-8-bits (1-byte) position.

In S103, the control circuit (block encryption executing section) 10 applies the AddRoundKey process to only the first divisional data. For example, assume a case where a first round key is a 64-bit value “FFFFFFFFFFFFFFFF”. Then, the control circuit 10 applies the AddRoundKey process to only the first divisional data “A0A1A2A3A4A5A6A7” and converts the value to “5F5E5D5C5B5A5958”. In other words, the control circuit 10 updates the value on the first block of the register 11 from “A0A1A2A3A4A5A6A7” to “5F5E5D5C5B5A5958”. Note that since the second divisional data is not converted at S103, a value “A8A9AAABACADAEAF” is stored on the second block. Accordingly, in S103, the data retaining means for retaining, on the respective blocks, pieces of divisional data to only some of which the AddRoundKey process has been applied is implemented by the register (data section) 11. That is, on the respective blocks of the register 11, the pieces of divisional data which are obtained by applying different processes are stored. Therefore, in the data retaining means, side-channel information radiated differs between the blocks, and tamper resistance is high.

Here, the side-channel information described above means information, such as information on power consumption that is externally observable, which is generated during operation of the control circuit 10 and the register 11 and which corresponds to processing content of the control circuit 10 and the register 11. Therefore, in a case where the processing content differs for each divisional data, pieces of the side-channel information radiated from the respective blocks are different from each other.

In S104, the control circuit 10 (block encryption executing section 10) applies the AddRoundKey process to only the second divisional data. For example, the control circuit 10 applies the AddRoundKey process to only the second divisional data “A8A9AAABACADAEAF” and converts the second divisional data to a value “5756555453525150”. In other words, the control circuit 10 updates the value on the second block of the register 11 from “A8A9AAABACADAEAF” to “5756555453525150”. In the AddRoundKey process in S104, the same round key as in S103 is used.

In S105, the control circuit 10 combines the first divisional data and the second divisional data with each other. For example, the control circuit 10 combines the first divisional data “5F5E5D5C5B5A5958” that is 64-bit data and the second divisional data “5756555453525150” that is 64-bit data to obtain a 128-bit value “5F5E5D5C5B5A59585756555453525150”. Here, the control circuit 10 combines the divisional data in order to make the MixColumns process executable in a subsequent step. As viewed from another aspect, the SubBytes process, the ShiftRows process and the AddRoundKey process are applicable even in a state in which data is divided. However, as for the application of the MixColumns process, it is required that the data is in an undivided state.

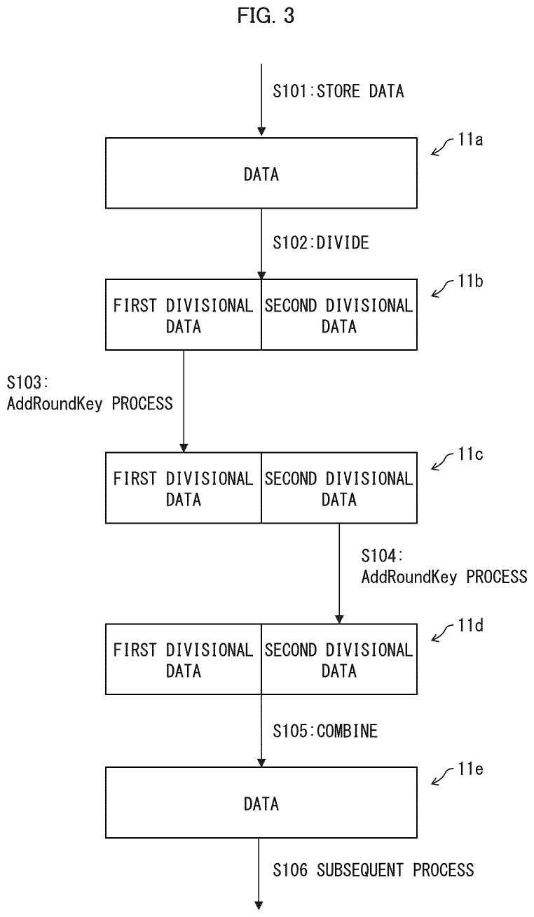

FIG. 3 is an example of a data diagram illustrating processing of data on the register 11 in steps S101 to S105 described above. Registers 11a to 11e of FIG. 3 correspond to the register 11 in respective steps S101 to S105.

In S106, the control circuit 10 performs the SubBytes process, the ShiftRows process, and the MixColumns process on combined data. Note that the processes from S106 to S110 are repeatedly performed (round number−1) times.

In S107, the control circuit 10 performs a process similar to that in S102, and divides the data on the register 11 into first divisional data on the first block and second divisional data on the second block.

In S108, the control circuit 10 performs a process similar to that in S103, and applies the AddRoundKey process to only the first divisional data. In the AddRoundKey process, a round key corresponding to the round number is used, and the same applies in the following description. Accordingly, in S108, the data retaining means for retaining, on the respective blocks, pieces of divisional data to only some of which the AddRoundKey process has been applied is implemented by the register (data retaining section) 11.

In S109, the control circuit 10 performs a process similar to that in S104, and applies the AddRoundKey process on only the second divisional data. In the AddRoundKey process in S109, a round key similar to that in S108 is used.

In S110, the control circuit 10 performs a process similar to that in S105, and combines the first divisional data and the second divisional data with each other.

In S111, the control circuit 10 determines whether or not the processes from S106 to S110 have been performed (round number−1) times, which is a prescribed number of times. When the control circuit 10 determines that the processes from S106 to S110 have been performed the prescribed number of times (S111: YES), the control circuit 10 preforms, in next S112, the SubBytes process, the ShiftRows process and the AddRoundKey process on the data on the register 11, and thereby updates the data. Thus updated data on the register 11 is used, as output data after the AES process, for other subsequent process(es). On the other hand, in a case where the control circuit 10 determines that the processes from S106 to S110 have not been performed the prescribed number of times (S111: NO), the control circuit 10 repeats the processes from S106.

The above description has dealt with a data processing method which is carried out by the semiconductor device 1. This method includes dividing steps (S102 and S107), block encryption executing steps (S103, S104, S108, and S109), and data retaining steps (S103 and S108).

The process in accordance with the present embodiment makes it possible to further improve the tamper resistance to a side-channel attack while suppressing an increase in operation time in a semiconductor device without performing a preliminary process such as masking.

Note that the processes in accordance with the present embodiment and processes in Embodiment 2 which will be described later are applicable to both of a case where the semiconductor device encrypts data and a case where the semiconductor device decrypts data.

### 3. Effect of Semiconductor Device

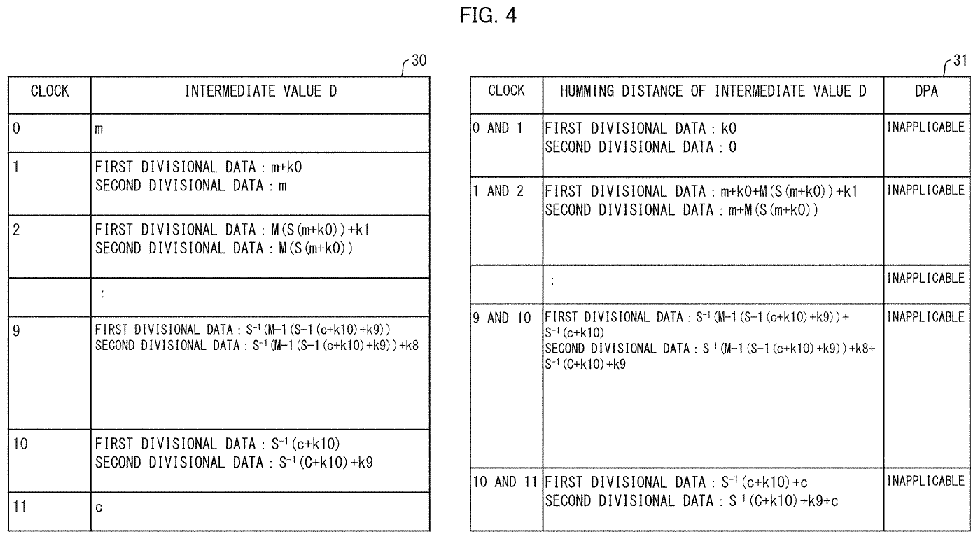

Next, the following is a supplement to an effect of the semiconductor device 1 in accordance with the present disclosure. FIG. 4 shows a table 30 which shows an example of a relation between (i) each clock (signal) that causes the control circuit 10 to synchronize and (ii) an intermediate value d that is in a stage of the each clock and that is retained on the register 11 in an AES process.

In FIG. 4, m represents plaintext data or divisional data that has been obtained by dividing the plaintext data. S(x) represents a result of applying, to data x, the SubBytes process and the ShiftRows process in this order. Further, M(x) represents a result of applying the MixColumns process to the data x. A function that has “−1” on an upper right side indicates inverse transformation of transformation by an original function. “c” and “C” represents output data to which the AES process has been applied, and kn represents a round key used in the n-th round.

Meanwhile, “+” indicates an XOR operation between bit strings. For example, “m+k0” of a first divisional data at clock 1 indicates a result of the XOR operation of the plaintext data m and a round key k0.

Table 31 shows an example of a relation of (i) each first clock and a second clock following the first clock, (ii) a Humming distance between an intermediate value d corresponding to the first clock and an intermediate value d corresponding to the second clock. Here, the Humming distance means the number of bits each of which has different values in a case where bits at the same positions in respective bit strings are compared with each other. For example, the Humming distance between bit strings “1000” and “1110” is 2.

In an AES process, in a case where the Humming distance satisfies all of conditions (1) to (4) below, a side-channel attack such as differential power analysis (DPA) becomes applicable, and a high-risk state occurs.
(1) Plaintext data m or output data c or C is included.
(2) Only one type of round key kn is included.
(3) M(x) or M⁻¹ (x) is not included.
(4) Only one S(x) or one S⁻¹ (x) is included.

For example, as shown in a row of clocks “1 and 2” in Table 31, the Humming distance “m+k0+M(S(m+k0))+k1” of first divisional data between clock 1 and clock 2 includes M(x) and a plurality of types of round keys k0 and k1. In addition, the Humming distance “m+M(S(m+k0))” of second divisional data includes M(x). Therefore, at this time, a side-channel attack cannot be applied to the data on the register 11.

In contrast, as illustrated in a row of clocks “10 and 11”, the Humming distance “S⁻¹ (c+k10)+c” of first divisional data between clock 10 and clock 11 satisfies all of the above-described conditions (1) to (4). At this time, in an AES process according to a conventional technology, a side-channel attack is applicable to the register 11 that retains data corresponding to the first divisional data. However, in a configuration of the semiconductor device 1 according to the present disclosure, the Humming distance “S⁻¹ (C+k10)+k9+c” of the second divisional data between clock 10 and clock 11 includes a plurality of types of round keys k9 and k10. Therefore, the Humming distance does not satisfy the above-described condition (2). At this time, side-channel information radiated is different between the first block and the second block, and the division position is unknown to an attacker. Therefore, the side-channel attack cannot be applied to the register 11 as a whole, and the tamper resistance is high.

### 4. Variation of Embodiment 1

With reference to the process shown in the flowchart of FIG. 2, an example has been described in which after the data to be processed is divided, only the AddRoundKey process is applied to each of pieces of divisional data and the pieces of the divisional data are combined. However, the present embodiment is not limited to this configuration.

For example, the control circuit 10 may be configure to apply the AddRoundKey process and the SubBytes process to each of the pieces of the divisional data, then combine the pieces of the divisional data, and subsequently perform the ShiftRows process and the MixColumns process in S106.

Alternatively, the control circuit 10 may be configure to apply the AddRoundKey process, the SubBytes process, and the ShiftRows process to each of the pieces of the divisional data, then combine the pieces of the divisional data, and subsequently perform the MixColumns process in S106.

However, in a case where the control circuit 10 is configured to apply the SubBytes process or the ShiftRows process to each of the pieces of the divisional data, a minimum information amount of each of the piece of the divisional data becomes 8 bits (1 byte), and the division position of the data is limited to a multiple position of 8 bits. Note that the “information amount” in the present disclosure may include the number of bits and the number of bytes, and other data sizes.

### Embodiment 2

The following description will discuss Embodiment 2 of the present invention. Note that for convenience of explanation, members having functions identical to those of members described in the foregoing embodiment are given respective identical reference numerals, and descriptions of those members will not be repeated. The present embodiment will discuss a configuration in which, in an AES process, data to be processed is divided into four pieces according to values of random numbers.

### 1. Configuration of Semiconductor Device

The same configuration as that in FIG. 1 is used in the present embodiment. However, as will be described later, a control circuit (dividing section) 10 in accordance with the present embodiment divides data to be processed into four pieces of divisional data including first divisional data to fourth divisional data. In addition, the control circuit 10 is configured to generate any one random value out of 00, 01, 10, and 11, as a 2-bit random number, that is, a random number in four ways. Further, a register (data retaining section) 11 retains, by a data retaining means, the first divisional data to the fourth divisional in data first to fourth blocks, respectively.

### 2. Process by Semiconductor Device

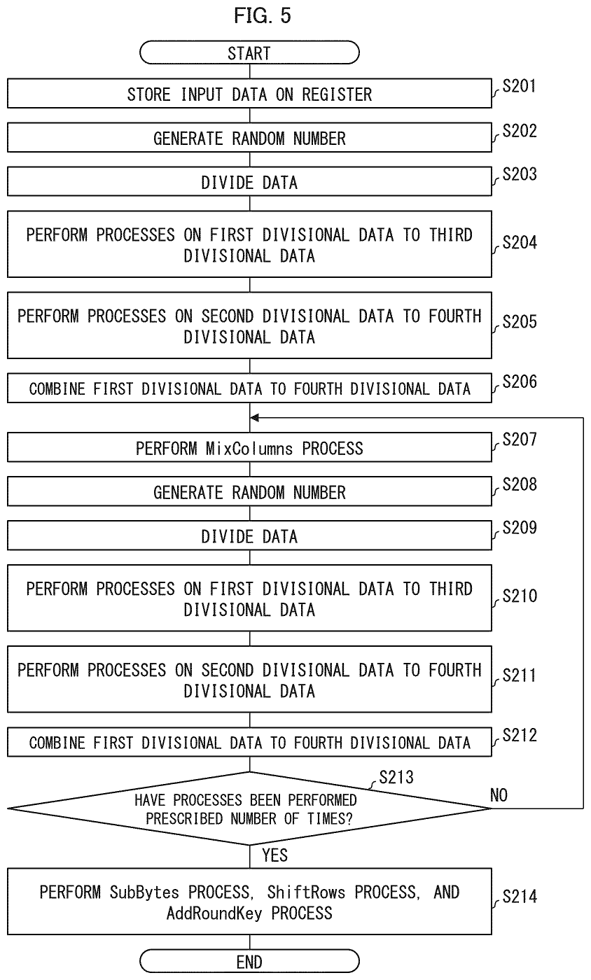

Next, the following will discuss a flow of a process to be performed by a semiconductor device 1. FIG. 5 is an example of a flowchart illustrating a flow of the process of the semiconductor device 1.

In S201, the control circuit 10 obtains input data that is to be subject to the AES process, and stores the input data on the register 11. In the present embodiment, as in the foregoing embodiment, the following will discuss, as an example, a case where the data input is a 128-bit value “A0A1A2A3A4A5A6A7A8A9AAABACADAEAF”.

In S202, the control circuit 10 generates a 2-bit random number for each predetermined information amount of the input data. On the assumption that the input data is 128-bit data and a 2-bit random number is generated for every 8 bits of the input data, for example, the control circuit 10 generates a value “11111010011000100101000011010011” as a 32-bit random number. Each 8 bits of the input data and a corresponding 2-bit random number are associated with each other.

In S203, the control circuit (dividing section) 10 performs a process for assigning, as division of the data on the register 11, each 8 bits of the input data to any one of the first divisional data to the fourth divisional data. This process is performed according to the corresponding 2-bit random number associated with the each 8 bits of the input data. As viewed from another aspect, the random number defines to which piece of divisional data each bit string having a predetermined information amount that is included in the data is to be assigned.

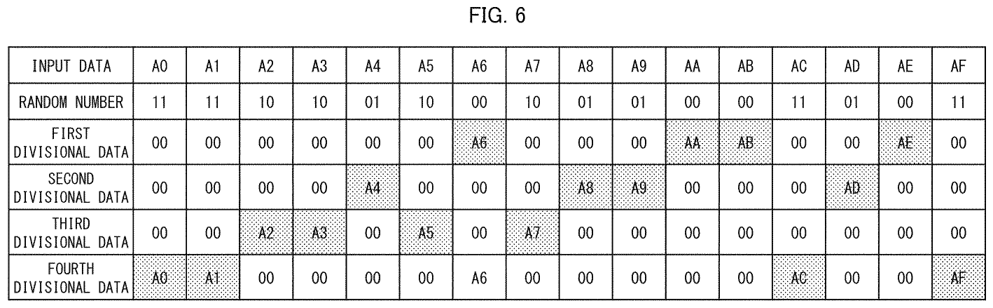

FIG. 6 is showing an example of a table correspondence relation between each 8 bits of the input data, each 2 bits of the random number, and the pieces of divisional data to which the each 8 bits of the input data are assigned. In the present embodiment, the random number “00” corresponds to the first divisional data and the random number “01” corresponds to the second divisional data. Further, the random number “10” corresponds to the third divisional data, and the random number “11” corresponds to the fourth divisional data.

In FIG. 6, 8 bits “A0” at the head of the input data are associated with a random number “11” and assigned to the fourth divisional data. Further, among sets of 8 bits of the input data, “A6”, “AA”, “AB”, and “AE” are assigned to the first divisional data. In a part which corresponds to the each 8 bits and to which no value is assigned in each divisional data, the value “00” is put. As a result, each divisional data has 128-bit value. In other words, for example, the value of the first divisional data is “000000000000A6000000AAAB0000AE00”. Note that the value that is put in the above-described part to which no value is assigned is not limited to “00” but may be “FF” or the like.

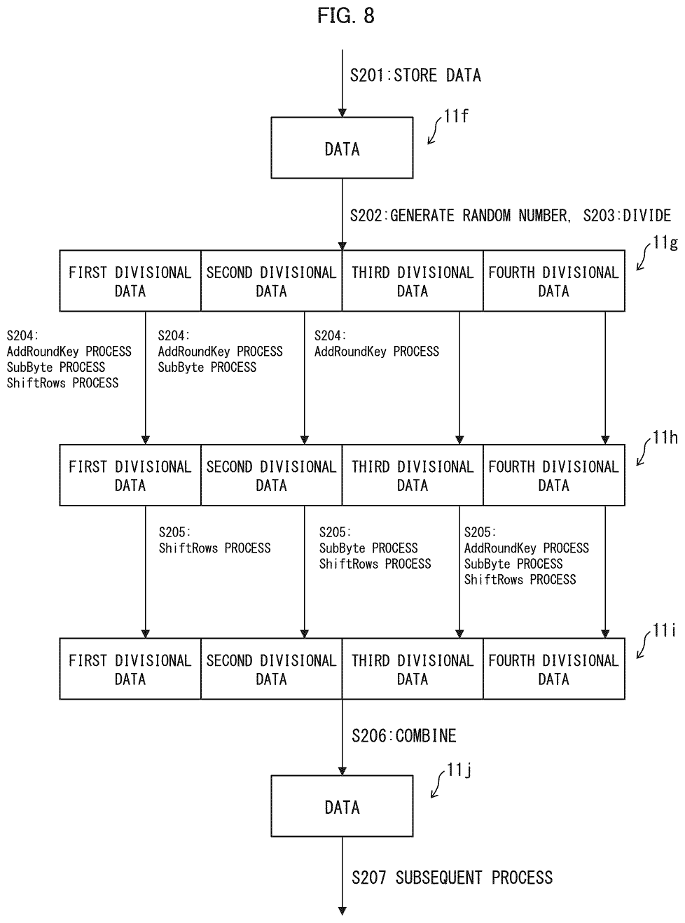

Similarly, the second divisional data to the fourth divisional data also have a 128-bit value, in which the value “00” is put in deficient parts. As viewed from another aspect, as illustrated in FIG. 8 that will be described later, the divisional data after division in the present embodiment occupies, on the register 11, a region corresponding to an information amount of 128 bits of original input data multiplied by 4, which is the number of divisions.

In S204, the control circuit (block encryption executing section) 10 performs each process on the first divisional data to the third divisional data. Specifically, the control circuit 10 performs an AddRoundKey process, a SubBytes process, and a ShiftRows process on the first divisional data. The control circuit 10 performs an AddRoundKey process and a SubBytes process on the second divisional data. Further, the control circuit 10 performs an AddRoundKey process on the third divisional data. At a time point of S204, the fourth divisional data is not converted. Accordingly, in S204, the data retaining means is implemented by the register 11 so as to retain, on respective blocks, pieces of divisional data to which processes that are different from each other and that are included in the AES process are applied or not applied. That is, on the respective blocks of the register 11, the pieces of divisional data that are obtained by applying processes that are different from each other are stored.

In the data retaining means, pieces of side-channel information radiated differ from one another among all blocks. In this way, in a case where the control circuit (dividing section) 10 is configured to divide data to be processed into three or more pieces of divisional data, it is more desirable to have a configuration in which on the register (data retaining section) 11, the pieces of side-channel information radiated differ from one another among all blocks. In addition, a division position of data, that is, to which divisional data each bit string of the data is assigned is unknown an attacker. Therefore, in the data retaining means, tamper resistance is very high.

For example, assume a case where the first round key has a 128-bit value “FFFFFFFFFFFFFFFFFFFFFFFFFFFFFFFF”. In this instance, the control circuit 10 applies the AddRoundKey process to the first divisional data “000000000000A6000000AAAB0000AE00” and converts the value to “FFFFFFFFFFFF59FFFFFF5554FFFF51FF”. Further, the SubBytes process is applied to the value after the AddRoundKey process, and the value is converted to a value “161616161616CB161616FC201616D116”. Furthermore, the ShiftRows process is applied to the value after the SubBytes process, and the value is converted to a value “1616FC1616CB201616161616161616D1”. Note that the control circuit 10 may perform, in a batch, each process on the divisional data by a matrix operation.

In addition, the control circuit 10 applies only the ShiftRows process to the 32-bit random number that has been generated in S202. Thus, for example, the value “11111010011000100101000011010011” is converted to a value “11100011110000111010010110010100”.

In S205, the control circuit (block encryption executing section) 10 performs each process on the second divisional data to the fourth divisional data. Specifically, the control circuit 10 performs a ShiftRows process on the second divisional data. Further, the control circuit 10 performs a SubBytes process and a ShiftRows process on the third divisional data. Furthermore, the control circuit 10 performs an AddRoundKey process, a SubBytes process, and a ShiftRows process on the fourth divisional data. In S205, the first divisional data is not converted. Note that in the AddRoundKey process on each divisional data in S204 and S205, the same round key is used.

In S206, the control circuit 10 combines the first divisional data to the fourth divisional data together.

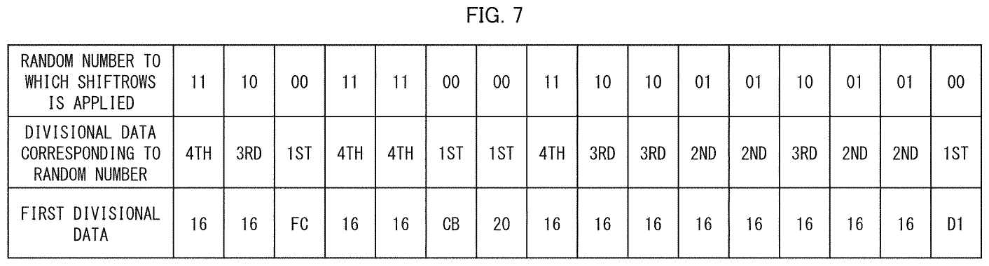

FIG. 7 is a table showing an example of a correspondence relation between the 32-bit random number to which the ShiftRows process is applied, divisional data corresponding to each 2 bits of the random number, and the first divisional data at the completion of the process(es) of S205.

In the example illustrated in FIG. 7, in a column in which the value of 2 bits of the random number is “00” that corresponds to the first divisional data, the 8-bit value of the first divisional data is a value other than “16”. Further, in a column in which the value of 2 bits of the random number is “01” that corresponds to the second divisional data, “10” that corresponds to the third divisional data, or “11” that corresponds to the fourth divisional data, the 8-bit value of the first divisional data is “16”. The value of “16” corresponds to parts in which the value “00” is put when the input data is divided.

The control circuit 10 extracts, from the first divisional data, a value in the parts that correspond to the column in which the value of 2 bits of the random number is “00”. Similarly, the control circuit 10 extracts, from the second divisional data, a value in a part that corresponds to the column in which the value of 2 bits of the random number is “01”. Further, the control circuit 10 extracts, from the third divisional data, a value in a part that corresponds to the column in which the value of 2 bits of the random number is “10”. Furthermore, the control circuit 10 extracts, from the fourth divisional data, a value in a part that corresponds to the column in which the value of the 2 bits of the random number is “11”.

Then, the control circuit 10 makes a 128-bit value by combining those 8-bit values in the above parts that have been extracted from the first divisional data to the fourth divisional data while maintaining the position of each part.

FIG. 8 is an example of a data diagram illustrating processing of data on the register 11 in steps S201 to S206 described above. Registers 11f to 11j of FIG. 8 correspond to the register 11 in respective steps S201 and S203 to S206.

In S207, the control circuit 10 performs a MixColumns process on combined data. The processes from S207 to S212 are repeatedly performed (round number−1) times.

In S208, the control circuit 10 carries out a process similar to that in S202, and generates a 2-bit random number for each predetermined information amount of the data. Note that it is possible to have a configuration in which the process of S208 is not performed and the same value as that of the random number generated in S202 is used in a subsequent process.

In S209, the control circuit 10 performs a process similar to that in S203 as division of the data. Then, the control circuit 10 performs a process for assigning each 8 bits of the data to any one of the first divisional data to the fourth divisional data in accordance with a 2-bit random number associated with the each 8 bits.

In S210, the control circuit 10 performs a process similar to that in S204, and performs, on the first divisional data to the third divisional data, each process included in the AES process.

In S211, the control circuit 10 performs a process similar to that in S205, and performs, on the second divisional data to the fourth divisional data, each process included in the AES process.

In S212, the control circuit 10 carries out a process similar to that in S206, and combines the first divisional data to the fourth divisional data together.

In S213, the control circuit 10 determines whether or not the processes from S207 to S212 have been performed (round number−1) times, which is a prescribed number of times. When the control circuit 10 determines that the processes from S207 to S212 have been performed the prescribed number of times (S213: YES), the control circuit 10 performs, in next S214, the SubBytes process, the ShiftRows process and the AddRoundKey process on the data on the register 11, and thereby updates the data. Thus updated data on the register 11 is used, as output data after the AES process, for other subsequent process(es). On the other hand, in a case where the control circuit 10 determines that the processes from S207 to S212 have not been performed the prescribed number of times (S213: NO), the control circuit 10 repeats the processes from S207.

The process in accordance with the present embodiment makes it possible to improve the tamper resistance to a side-channel attack more than that described in Embodiment 1.

### 3. Variation 1 of Embodiment 2

In the process shown in the flowchart of FIG. 5, an example in which data to be processed is divided into four pieces has been described, but the present embodiment is not limited to such a configuration.

For example, the control circuit 10 may be configured to generate, for each predetermined information amount of data, any one random value out of 00, 01, and 10 as a random number in three ways, and associate the random value. In the above configuration, the control circuit 10 performs a process for assigning each bit string having the information amount to any one of first divisional data to third divisional data according to the random number thus associated.

Alternatively, the control circuit 10 may be configured to generate, for each predetermined information amount of data, one random value 0 or 1 as a 1-bit random number or a random number in two ways, and associate the random value. In the above configuration, the control circuit 10 performs a process for assigning each bit string having the information amount to the first divisional data or the second divisional data according to the random number thus associated. Further, in the above configuration, in a case where it is assumed that the input data is 128-bit data and a 1-bit random number is generated for each 8 bits of the input data, the control circuit 10 generates a 16-bit random number.

### 4. Modification 2 of Embodiment 2

The control circuit 10 is not limited to a configuration in which each bit string of data to be processed is assigned to any one of pieces of divisional data according to the value of a random number.

For example, it may be possible to have a configuration in which, in accordance with a part of each bit string of data, to which divisional data the bit string is to be assigned may be predefined. Further, bit strings of data that are assigned to certain same divisional data may or may not be continuous. Furthermore, information amounts of respective pieces of divisional data may be different from each other. For example, in a case where the input data is 128-bit data, the information amounts of the first divisional data to the fourth divisional data may be 16 bits, 48 bits, 32 bits, and 32bits. In addition, the information amount of each divisional data may be changed every time the data is divided.

### Software Implementation Example

Functions of the semiconductor device 1 (hereinafter, referred to as “device”) can be realized by a program for causing a semiconductor device as the device, the program causing the semiconductor device to function as each control block of the device.

The program can be stored in at least one computer-readable non-transitory storage medium. The storage medium can be provided in a computer 100 that includes the device, or the storage medium does not need to be provided in the computer 100. In the latter case, the program can be made available to the device via an arbitrary wired or wireless transmission medium.

Further, one or some or all of respective functions of the control blocks described above can be realized by a logic circuit. For example, an integrated circuit in which a logic circuit that functions as each of the control blocks is formed is also encompassed in the scope of the present invention. In addition, the respective function of the control blocks can be realized by, for example, a quantum computer.

Further, each process described in the above embodiments may be executed by artificial intelligence (AI). In this case, the AI may be operated by the device or may be operated by another device (e.g., an edge computer or a cloud server).

Aspects of the present invention can also be expressed as follows:

A semiconductor device (1) in accordance with aspect 1 of the present invention is configured to include: a dividing section (10) configured to divide data into two or more pieces of divisional data; a block encryption executing section (10) configured to apply, to only one or some of the two or more pieces of divisional data, a specific process included in a block encryption algorithm; and a data section retaining (11) configured to retain, in respective blocks, the two or more pieces of divisional data to only one or some of which the specific process has been applied, so that pieces of side-channel information radiated differ from each other between at least some of the blocks.

A semiconductor device in accordance with aspect 2 of the present invention is configured such that in the above aspect 1, the dividing section divides the data into the two or more pieces of divisional data such that at least any two pieces of the two or more pieces of divisional data differ from each other in information amount.

A semiconductor device in accordance with aspect 3 of the present invention is configured such that in the above aspect 1 or 2, the dividing section performs a process for assigning, according to a value of random number which has been generated for each predetermined information amount of the data, each bit string which has the predetermined information amount and which is included in the data to any one piece of the two or more pieces of divisional data.

A semiconductor device in accordance with aspect 4 of the present invention is configured such that in any one of the above aspects 1 to 3, the dividing section divides the data into three or more pieces of divisional data; and the data retaining section retains, in respective blocks, the three or more pieces of divisional data so that pieces of the side-channel information radiated differ from one another among all of the blocks.

A semiconductor device in accordance with aspect 5 of the present invention is configured such that in any one of the above aspects 1 to 4, the block encryption algorithm is Advanced Encryption Standard (AES); and the specific process includes an AddRoundKey process.

A processing method in accordance with aspect 6 of the present invention is a data processing method which is carried out by a device (1), the method including: a dividing step of dividing data into two or more pieces of divisional data; a block encryption executing step of applying, to only one or some of the two or more pieces of divisional data, a specific process included in a block encryption algorithm; and a data retaining step of retaining, in respective blocks, the two or more pieces of divisional data to only one or some of which the specific process has been applied, so that pieces of side-channel information radiated differ from each other between at least some of the blocks.

A control program in accordance with aspect 7 of the present invention is configured in any one of the above aspects 1 to 5 to cause a semiconductor device to function as the dividing section and the block encryption executing section.

A storage medium in accordance with aspect 8 of the present invention is configured in the above aspect 7 to store the control program and to be computer-readable.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 semiconductor device
2 memory
10 control circuit (dividing section, block encryption executing section)
11, 11a to 11i register (data retaining section)
100 computer

1. A semiconductor device comprising:
a dividing section configured to divide data into two or more pieces of divisional data;
a block encryption executing section configured to apply, to only one or some of the two or more pieces of divisional data, a specific process included in a block encryption algorithm; and
a data retaining section configured to retain, in respective blocks, the two or more pieces of divisional data to only one or some of which the specific process has been applied, so that pieces of side-channel information radiated differ from each other between at least some of the blocks.

2. The semiconductor device as set forth in claim 1, wherein the dividing section divides the data into the two or more pieces of divisional data such that at least any two pieces of the two or more pieces of divisional data differ from each other in information amount.

3. The semiconductor device as set forth in claim 1, wherein the dividing section performs a process for assigning, according to a value of random number which has been generated for each predetermined information amount of the data, each bit string which has the predetermined information amount and which is included in the data to any one piece of the two or more pieces of divisional data.

4. The semiconductor device as set forth in claim 1, wherein:
the dividing section divides the data into three or more pieces of divisional data; and
the data retaining section retains, in respective blocks, the three or more pieces of divisional data so that pieces of the side-channel information radiated differ from one another among all of the blocks.

5. The semiconductor device as set forth in claim 1, wherein:
the block encryption algorithm is Advanced Encryption Standard (AES); and
the specific process includes an AddRoundKey process.

6. A data processing method which is carried out by a device, the method comprising:
a dividing step of dividing data into two or more pieces of divisional data;
a block encryption executing step of applying, to only one or some of the two or more pieces of divisional data, a specific process included in a block encryption algorithm; and
a data retaining step of retaining, in respective blocks, the two or more pieces of divisional data to only one or some of which the specific process has been applied, so that pieces of side-channel information radiated differ from each other between at least some of the blocks.

7. A non-transitory computer-readable storage medium, for storing a control program for causing a semiconductor device to function as the dividing section and the block encryption executing section which are recited in claim 1.
